(19) United States
(12) Patent Application Publication
(10) Pub. No.: US 2006/0085374 A1
(43) Pub. Date: Apr. 20, 2006

(54) Automatic records management based on business process management

(75) Inventors: Lauren Mayes, Laguna Beach, CA (US); Bao Vu, Mission Viejo, CA (US)

Correspondence Address: MCDERMOTT WILL & EMERY LLP, 18191 VON KARMAN AVE., SUITE 500, IRVINE, CA, 92612-7108, US

(73) Assignee: FileNet Corporation, Costa Mesa, CA (US)

(21) Appl. No.: 10/964,694

(22) Filed: Oct. 15, 2004

(51) Int. Cl. G06F 17/30

(52) U.S. Cl. 707/1

(57) ABSTRACT

A records management method that automatically classifies records and manages the records based on the classification. The method incorporates processes for receiving a classification scheme for a record, receiving declaration of an asset as a record, automatically classifying the record according to the classification scheme, and workflow processes for vital records review and review for approval of disposition of records. Numerous method variations, as well as related systems and computer-readable media are also disclosed.

### BACKGROUND

1. Field

The present disclosure relates generally to records management and, more particularly, to automated records management, including vital record review and review to ensure proper record disposition, based on automated classification of the record.

2. Related Art

Records management has become increasingly essential to the success and future of a business.

Technological advances have given rise to greater reliance on electronic information in dispersed data systems. The amount of information to be gathered has also increased. For example, the Internet and its e-mail and web-based content gathering capabilities have aided the proliferation of data such as never before seen. The increasing amount of hard copy information has aided this proliferation as well.

Along with technological advances and the widespread propagation of data, a new age of corporate governance has also resulted in a greater emphasis on records management. Emphasis on issues such as corporate fraud have led to large-scale corporate liability and corporate failures. Greater focus is being given to corporations and their executives, as well as corporate compliance with new laws enacted as a part of this new age of corporate governance

Corporate non-compliance is a major source of corporate liability, resulting in increased complexity for records management systems. Many compliance policies have been embodied in legislation. The Sarbanes-Oxley Act and the Health Insurance Portability and Accountability Act of 1996 are examples of such legislation. Due to regulations such as these, it may be deemed necessary for a corporation to manage and maintain its records in a particular manner.

A significant number of companies now maintain formal records management programs, and it is widely agreed that such programs are important to the success of a business. However, current records management programs may not address the needs of today's businesses in that they have not been updated in accordance with technological advances. For example, many of today's records management programs do not incorporate electronic records.

Current records management programs may also lack protections that promote the consistent application and enforcement of records management policies. For example, some information technology systems may not be structured to support desired records management policies. Moreover, records may be incorrectly classified due to differences of opinion among users that manually perform classification operations.

Moreover, process information required for audit and compliance is often not recorded. For example, vital records may also not be reviewed and/or updated by the appropriate persons.

Records management programs may also lack timely retention and disposition policies. Accordingly, where records are inaccessible or destroyed too soon, a business may be unable to produce such records in court to defend a claim, and such records may be costly to recreate. Where records are kept longer than required, avoidable and costly storage costs may result.

While records management programs have been developed to address these issues, many such programs have failed because, among other things, they are perceived as burdensome and time-consuming to the user.

There is a need for a records management system that is less burdensome and time-consuming to the user.

There is further a need for a records management system that incorporates mechanisms for timely retention and disposition of records. There is still further a need for a records management system that has kept pace with technological advances, including by incorporating electronic records. There is even further a need for a records management program that promotes the consistent application and enforcement of records management policies.

### SUMMARY

The present disclosure addresses the needs noted above. In accordance with one embodiment of the present disclosure, a computer-implemented method is provided for automated records management based on automated records classification. The method includes receiving a file plan configured to classify records, including physical and electronic records, receiving declaration of an asset as a record, automatically classifying the record according to the file plan, and managing the record according to the file plan, including implementing workflows associated with managing the record.

In accordance with another embodiment of the present disclosure, a method is provided for vital records review. The method includes receiving declaration of an asset as a vital record, receiving a vital record review event configured to launch a vital record review workflow associated with the vital record, wherein the vital record review event is associated with at least one designated reviewer, and upon determination of the occurrence of the vital record review event, automatically launching the vital record review workflow.

In accordance with yet another embodiment of the present disclosure, a method is provided for cutoff workflow. The method includes receiving a cutoff event configured to launch a cutoff workflow associated with the record, wherein the cutoff event is contingent upon an approval of at least one end user, upon determination of the occurrence of the cutoff event, automatically launching the cutoff workflow, transmitting information associated with the cutoff event to the at least one end user upon whom the approval of the cutoff event is contingent, and after receiving an indication of approval by the at least one end user, commencing a disposition phase for the record.

In accordance with yet another embodiment of the present disclosure, a computer-based system is provided for managing records based on automated records classification. The system includes a memory system including a file plan configured to classify a record, wherein the memory system is configured to receive declaration of an asset as a record, a classification device configured to automatically classify the record according to the file plan; and a records management system configured to initiate management of the record according to the file plan.

In accordance with yet a further embodiment of the present disclosure, computer readable media is provided containing programming for managing records based on automated records classification that, when executed on a computer, causes a processor to perform the steps of receiving a file plan configured to classify records, including physical and electronic records; receiving declaration of an asset as a record; automatically classifying the record according to the file plan; and managing the record according to the file plan, including implementing workflows associated with the managing the record.

In accordance with still another embodiment of the present disclosure, computer-readable media is provided containing programming for automatic implementation of review of vital records that, when executed on a computer, causes a processor to perform the steps of receiving declaration of an asset as a vital record; receiving a vital record review event configured to launch a vital record review workflow associated with the vital record, wherein the vital record review event is associated with at least one designated reviewer; and upon determination of the occurrence of the vital record review event, automatically launching the vital record review workflow.

In accordance with another embodiment of the present disclosure, computer-readable media is provided containing programming for automatic implementation of reviewing a record in a records management system in order to approve disposition of the record that, when executed on a computer, causes a processor to perform the steps of receiving a cutoff event configured to launch a cutoff workflow associated with the record, wherein the cutoff event is contingent upon an approval of at least one end user; upon determination of the occurrence of the cutoff event, automatically launching the cutoff workflow; transmitting information associated with the cutoff event to the at least one end user upon whom the approval of the cutoff event is contingent; and after receiving an indication of approval by the at least one end user, commencing a disposition phase for the record.

It is understood that other embodiments of the present disclosure will become readily apparent to those skilled in the art from the following detailed description, wherein it is shown and described only exemplary embodiments of the disclosure by way of illustration.

### BRIEF DESCRIPTION OF DRAWINGS

Aspects of the present disclosure are illustrated by way of example, and not by way of limitation, in the accompanying drawings wherein:

FIG. 1 illustrates a process-centric records declaration process for an insurance company in accordance with one embodiment of the present disclosure.

FIG. 2 illustrates a data model that can be used for a file plan in accordance with one embodiment of the present disclosure.

FIG. 3 illustrates a vital record review workflow that may be automatically launched upon the occurrence of a vital record review action or event as defined by the file plan, in accordance with one embodiment of the present disclosure.

FIG. 4 illustrates a screenshot a review or reviewer group might encounter in a vital record review in accordance with one embodiment of the present disclosure.

FIG. 5 illustrates a screenshot a records manager might see in a vital record review workflow in accordance with one embodiment of the present disclosure.

FIG. 6 illustrates a cutoff workflow that may be automatically launched upon the occurrence of a cutoff action or event as defined by the file plan, in accordance with one embodiment of the present disclosure.

FIG. 7 illustrates a workflow for physical records management in accordance with one embodiment of the present disclosure.

FIG. 8 illustrates a computer-based records management system used to implement the automated declaration and records management processes described in the present disclosure.

FIG. 9 is a block diagram representation of a single architecture that may be provided for content management, records management, web content management, collaboration and digital asset management at the application tier, while one content engine and one process engine are used to manage the process and content for all the separate functions indicated in accordance with another embodiment of the present disclosure.

### DETAILED DESCRIPTION OF THE PRESENT DISCLOSURE

The present disclosure provides systems, methods and computer programs for automated records management based on automated records classification. The present disclosure also provides systems, methods and computer programs for records management that incorporate a vital records review workflow that fosters the maintenance and updating of vital records. As part of the records management system that incorporates vital records workflow, or alternatively in lieu of a system that incorporates vital records workflow, the records management system may also incorporate a cutoff workflow configured to trigger a disposition phase for a record upon occurrence of a cutoff event and approval of the record's disposition.

The records management application may be accessed by a user, whether a regular end user, records administrator, records manager or reviewer (privileged user) over a Java-based API that indicates the pertinent records management operation that the user can perform. These operations may include a declaration API, a record management API, a disposition API and a file plan management API. The APIs may incorporate XML technology for ease of use, as well as ease of import and export of information in the records management system.

The records management system described herein may be used to declare, classify and manage records of different types, secure repositories that contain records, create retention and disposition rules for records, control access to records, retrieve records based on search criteria, destroy records that are no longer used, review vital records, and add records with minimal user intervention.

Record Declaration: Identification of an Asset as a Record

The records management systems, methods and computer readable media of the present disclosure are designed to manage records of various types, including but not limited to, electronic documents and e-mails, physical records or artifacts, vital records and permanent records. A record can be any asset that an organization desires to maintain and manage in a reliable manner.

The present disclosure also provides a business process management system that automates the processing of documents and events, among other things, in a business context. The business process management system may be used to automate not only records management, but also records classification.

The business process management system may be used to implement workflow processes that capture a business process and automate it. A workflow process or automated business process may be defined as a series of processing steps in a particular sequence, including conditional steps and branching steps, where each step could involve user input and work. A workflow process may also involve an automated computer program (e.g., an automated programmatic check of policy coverage and limits in the course of processing an insurance claim). Workflow processes may be designed by system analysts and may be recorded in a process engine. In this manner, they may be executed repeatedly in the course of running a business.

An electronic record may be information recorded in a form that requires a computer or other machine to process the information. Electronic records may include e-mail messages. Physical records may be information recorded in physical form, such as a file containing paper records, videotapes, etc. Physical artifacts can include items such as museum sculptures or paintings.

Vital records may be records that are necessary for meeting operational responsibilities in an emergency or are otherwise essential or critical to the record holder. Permanent records may include those records identified as having sufficient historical or other value to warrant continued preservation by the organization beyond the time they are ordinarily needed for administrative, legal or fiscal purposes.

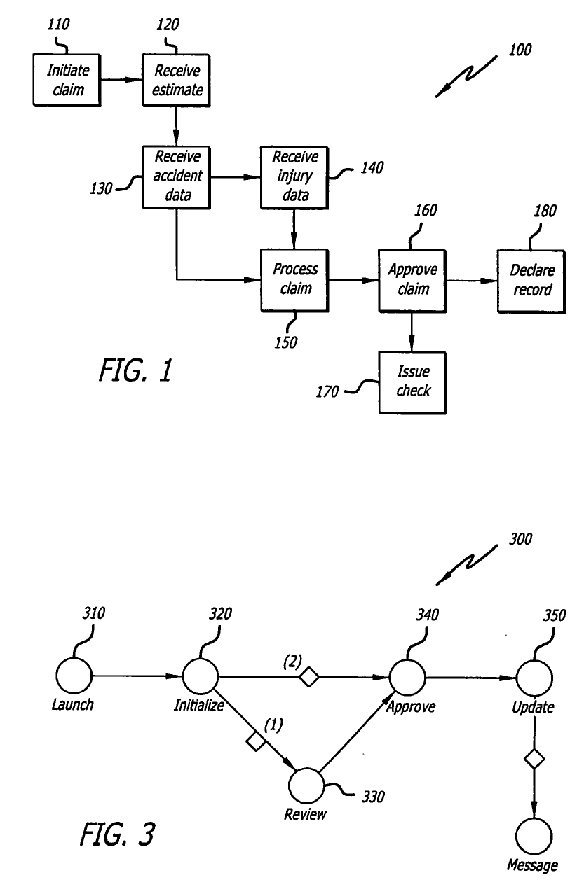

Record declaration may be performed when a potential record is added to the system. In the case of electronic content, declaration may occur when a document is created or published, or upon the creation of a new document version, or when an e-mail is transmitted. For electronic documents as well as other types of records, the records may be automatically declared. In the course of the automated business process in FIG. 1, in the case of a physical artifact, declaration may occur, for example, when the physical artifact is received by a company.

Records may also be generated in a variety of other uses and applications, e.g., part of a transaction, or during the course of a process. Process-centric records may be created as part of a company's line of business.

For example, insurance companies often approve or deny claims as part of their line of business. Referring now to FIG. 1, illustrated is a process-centric records declaration process 100 for an insurance company in accordance with one embodiment of the present disclosure. Process 100 may be an automated business process or workflow. At step 110, the claim process is initiated whereby an insured makes a claim against his policy. At step 120, an estimate is received by the insurance company. The estimate may be received directly from the insured, from a company that performs the estimate, or any other entity from which the insurance company desires to obtain an estimate. At step 130, accident data is received. If the accident involves an injury, data related to the injury may also be obtained at step 140. At step 150, the claim is processed, then approved at step 160. At step 170, a check is issued in the amount approved. Finally, a record is declared at step 180 regarding the approved claim.

Records may be automatically declared, e.g., in connection with the insurance claim process, based on contextual information associated with an automated business process (or workflow). In the course of the automated business process in FIG. 1, it may be determined and recorded that this is an accident claim involving injury which has been approved for payment. The business process management system provides for collection and recordation this kind of information, so that it may be later used during the process. This contextual information allows the automated business process to declare the claim as a record.

It should also be understood that a separate set of records could be declared for various discrete steps. For example, a separate set of records could be declared for the issued check, and this record could be maintained in a set of records of all issued checks for a certain period. Such a set of records related to issued checks might be useful for accounting, for instance.

The system may be configured such that any user can declare records by adding documents. The declaration may be made from the users workplace using entry templates, from a productivity tools suite such as MICROSOFT OFFICE™, an email program such as MICROSOFT OUTLOOK™, and events that automatically declare the record.

Upon declaration, the system may be designed so that the record cannot be deleted, even by the creator of the record. Access rights may be changed for a record that impacts the document's access rights.

Automatic Records Classification:

Classification may occur based on a classification scheme or file plan that incorporates assigned codes or categories, or any other descriptive information used to manage a record, including for purposes of the record's accessibility, retrieval, retention, disposition or any other management operations.

Contextual information collected by and associated with a business process or workflow may allow the automated business process to classify a record automatically according to a hierarchy of classifications or other classification scheme defined in the file plan. For example, for an insurance claim, a claim record classification hierarchy may include subtypes e.g., subtype accident, with a subtype below that of accident with injury, and a further subtype below that of accident with injury approved for payment. In FIG. 1, the contextual information collected in the course of the claim processing workflow allows the workflow to classify the record automatically as of type accident claim with injury approved for payment. Other subtypes for insurance claims may be life, injury and fire. Still further subtypes may be included within these subtypes. Non-hierarchical classifications schemes may also be used.

A single person, such as a records administrator, may be charged with responsibilities for designing a classification scheme, defining a new file plan, configuring naming patterns and phases, as well as defining and modifying disposition schedules. Major categories of the file plan may be category hierarchy and disposition schedules.

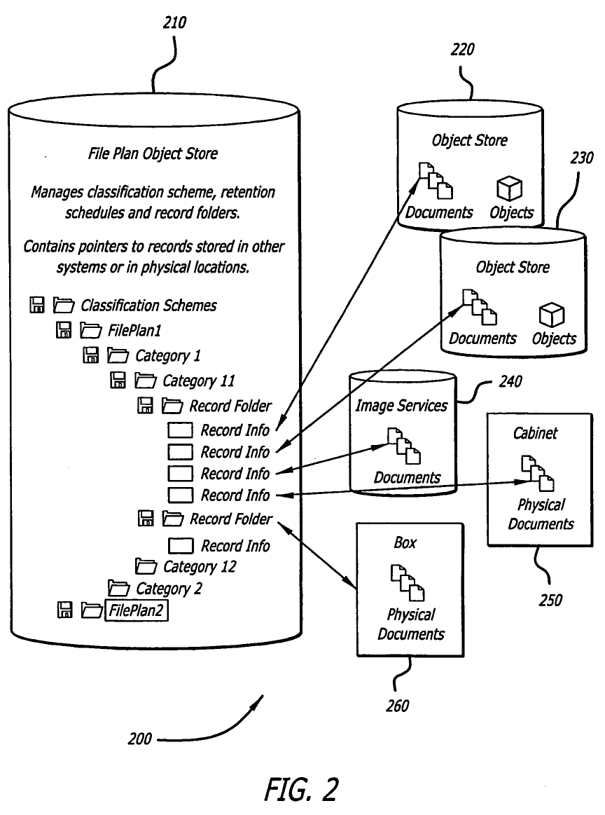

Referring now to FIG. 2, illustrated is one embodiment of a data model 200 that can be used for a file plan in accordance with the present disclosure. In this illustration, the file plan is used to manage records across object stores and repositories. As illustrated, the file plan uses a file plan object store 210 which manages classification schemes, retention schedules and record folders. The file plan object store 210 contains pointers to records stored in other systems or in physical locations. This file plan object store also incorporates a category hierarchy which may be the primary classification for records, and may include categories, as well as various types of folders and corresponding volumes. More particularly, the file plan may incorporate a classification scheme, record category, record folder, record part or record type that can be used to manage the record.

The category hierarchy may also include a tree structure defining how records are organized, and the category hierarchy may also propagate security and support disposition schedules. The category hierarchy may include a flexible hierarchical structure that is designed to fit the unique needs of an organization. The category hierarchy may determine the scheme for classifying records so that the records may be automatically classified by a records management system, without user intervention.

The category hierarchy may be determined by business function. For example, a category hierarchy may be organized according to a function/activity/transaction model wherein the first level determines functional groupings, the second level determines activities within the function, and the lowest level represents a transaction. The hierarchy may also be designed to facilitate access. In this manner, security may be more easily controlled, user access in terms of browsing may provide better performance and the hierarchy may facilitate aggregation for purposes of disposition.

Alternatively to file plan design based on business function, a file plan may be designed so that each folder in the category is a client file that contains that particular client's records, and once the client folder is closed, cutoff may be triggered so that active use of the record ends and it begins its retention period.

As yet another alternative to file plan design based on business function, a file plan may be designed so that different types of records are filed into different folders. As yet another alternative, the file plan may be designed so that each sub-category represents a project, and each project may have a collection of folders to manage different records related to the project. An external event related to a project milestone may be used to trigger cutoff so that active use of the record ends and the retention period begins.

The record category may be added to the root of the file plan. The record category may also be added to an existing category to establish a hierarchy. The required properties of a category may be the category name which may be descriptive of the category, the category identifier which may be a more cryptic string identifier often containing a numeric code, and a reviewer which may default to the user who is adding the category.

A record folder may be added to a category. Conceptually, the record folder may be the most common level for managing records. The required properties for a folder may include the folder class such as a content engine object class defining the type of folder. The folder class may be defined by the data model. The folder properties may also include a name, identifier and reviewer much like the record category.

Generally, a record folder may not contain sub-folders, but may contain volumes. The first volume may be automatically added when the record folder is created, and a name may be automatically generated based on the folder name. When a new volume is added, the previous volume may be automatically closed. Volumes may be used to partition groups of records, whether similar or not. For example, a record folder may contain all invoices while volumes may be used to partition by month. A volume may be required to include a reviewer, which may default to the user requesting the volume.

As shown in FIG. 2, the data objects and physical repositories 220, 230, 240, 250, 260 may be configured in conformance with the classic model of a software object that has been developed in object-oriented programming to include one or more attributes and one or more methods.

A broad variety of characteristics may be assigned as attributes to the file plan object 210, object stores 220, 230 and other objects. For example, these objects may incorporate attributes that are related to the records that are embodied in the software object such as a name for the record, a description of the record, the type of record, an identification of the holders of the record. Audit information may also be contained as an attribute relating to the record such as who accesses an object, when it is modified, who authorizes the modification, who generates documentation related to the object or repository, and when these events take place. Electronic signatures that may have been procured in connection with an object store such as object stores 210, 220, 230 may be contained as an attribute. Notifications that should be issued upon a change in an aspect of a data object, security information relating to a data object, status information that is associated with the record (such as lost item), relevant dates (e.g., creation date, expiry date, and/or key timelines, including multiple, periodic or cyclical information), and relationships between the record software object and other components may be contained as attributes.

Although each of these characteristics may be illustrated as an attribute of the object, each of these may also or instead be stored as separate components or objects in the record management system.

The data model 200 includes pointers from the file plan object store 210 to records stored in other systems or locations. One such pointer is to object stores related to documents 220, 230 which are the main record types and thus use more space. The data model also includes pointers to an image service repository 240, a cabinet repository for physical documents 250 that may be located in cabinets, as well as a box repository for physical documents 260 that may be located in boxes. This design provides for a file plan that incorporates an intuitive scheme that can be readily used by the records administrator to generate a file plan. Based on this user-friendly structure, a records administrator may customize the file plan to fit the company's needs.

Methods may be related to the records, including methods that include or relate to retention and disposition rules, timed events, notifications, reports and trends and forecasts. Each of these methods may constitute software subroutines that initiate, alter or interrupt one or more processes. As with the attributes, the methods may be stored separately from the file plan object store or data object in another object or component.

A disposition schedule may be assigned to a category or folder in the file plan. Where disposition schedules have already been configured, they may be added while adding a new container. If the hierarchy is also constructed, the disposition schedule may be added to the appropriate level after hierarchy construction. A disposition schedule may be automatically inherited by lower level entities. A disposition may also be designed to be overridden.

A disposition schedule may be associated with a record category or folder or other element of a file plan. The disposition schedule may include several elements. For example, a disposition schedule may include an event trigger that triggers cutoff. Cutoff may be the beginning of the retention period which signals the end of active use. Upon a cutoff action, a workflow may be automatically launched for approval of the cutoff. An event offset may optionally be provided as part of a disposition schedule, and may delay time between an event trigger and a cutoff. Disposition phases may be defined to control the retention of records, and each phase of disposition may have an action associated with a workflow.

The event triggers used in a file plan may be internal events, such as those related to the property of a particular category, folder, volume or record. The event trigger may also be an external event that represents an action that occurs outside the system. For example, in a doctors office, a patient may decide to terminate his relationship and see another doctor. Such a decision may trigger a cutoff so that the patient records begin their disposition phase. A recurring event may include a start date and frequency. A recurring event may be a date for review of vital records. The event may also be a predefined date. For example, all records for a certain calendar year may be cutoff at the end of a particular year.

Disposition phases may be defined within the file plan such that they include actions. Each action may have a type and an associated workflow that is launched to carry out the action. In this manner, workflows may be configured for use in a disposition schedule. Workflows may also be duplicated and modified to implement multiple actions of the same type. For example, if a business commonly transfers records on an interim basis to a particular locale, the disposition schedule may include actions related to that transfer. Disposition phase action types may include review actions, export actions, interim transfer actions, transfer actions and destroy actions. A review action may indicate that a record should be reviewed to determine if its disposition should be changed. An export action may be used to copy records to an external system without removing them. A transfer action may be used to export records to an external system so that they may be removed afterwards. A destroy action may be used to remove records so they cannot be recovered. There may be an option used to retain metadata.

A disposition schedule may be pre-configured to trigger events and phase actions. In adding a new disposition schedule, a user may be required to provide a name for a schedule, select a trigger for the schedule, define a disposition event offset, select cutoff action (option) and set disposition phases. One or more disposition phases may be added to a disposition schedule in a file plan. Phases should be in logical order. For example, a disposition schedule should be defined so that nothing follows a destruction or transfer phase. A retention period should be included for each phase. For example, a record may be reviewed one year after its cutoff, and destroyed five years after its cutoff.

Record aggregation may define the file plan level that a schedule impacts. For example, it may define which record is cutoff and then is impacted by a disposition phase.

A disposition schedule may be inherited by folders in a category or the folders may have their own disposition schedules, whether according to record types or otherwise.

Records Management:

Records management may be performed through a Java-based API as noted hereinabove. Records management may incorporate a number of processes, which may be expressed in terms of workflows.

Vital Record Review Workflow:

Referring now to FIG. 3, illustrated is a vital record review workflow 300 in accordance with one embodiment of the present disclosure. This vital review workflow described is an example of a workflow that can be created in accordance with the present disclosure. However, it should be understood that a customer can configure, modify, or create new workflows to meet specific business needs. The workflow may be defined using a process designer which may be a part of a business process management system. At step 310, the vital record review workflow is launched. The launch may be a result of a vital record review event associated with a record's classification. This vital record review event may be triggered to ensure periodic reviews of vital records for reasons related to corporate compliance, for instance. The vital record review workflow may be launched in a nightly sweep indicating a vital record review action is due for any record folder, record category, volume or other descriptive information pertaining to a vital record.

At step 320, a vital record review workflow may be initialized when a reviewer and/or records manager connect to the records management system, although a records manager or system administrator may be free to use any workflow which they may design and/or customize for vital record review. This initialization process may include parameters for sending a review notice to the appropriate reviewer or reviewer group. Assuming appropriate authority has been given to the reviewer, the reviewer may then take actions like checking in new records and superseding old ones or any other operation the reviewer has the right to perform, including inputting comments related to the vital record and changing the next vital record review date.

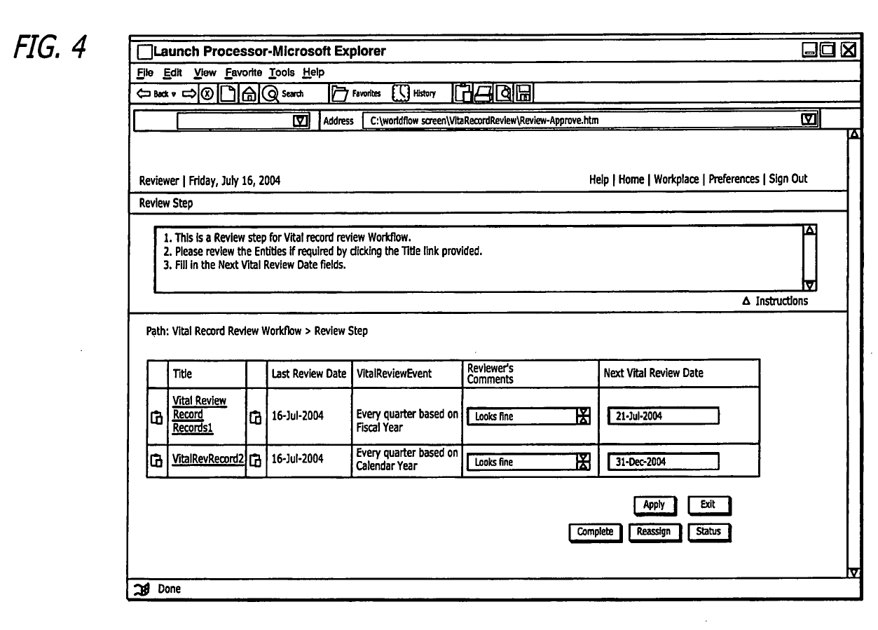

Referring now to FIG. 4, illustrated is a screenshot a review or reviewer group might encounter in a vital record review in accordance with one embodiment of the present disclosure. The screenshot guides the reviewer through the process by explaining that it is a vital records review, and that the user should select the records by clicking each link provided. The file plan may include a process for a reviewer to fill in the next vital review dates. The reviewer may also provide comments. In this example, the reviewer has commented next to the link for the pertinent record that each record “looks fine.” Next to the link for the first record, the reviewer has filled in the next vital review date as Jul. 21, 2004. For the next record and next to the relevant link, the reviewer has filled in the date as Dec. 31, 2004.

Once the reviewer or reviewer group has reviewed the record, a message may be sent to the system, indicating that the record has been reviewed. The message may be sent manually by the reviewer, or automatically by the system upon receiving appropriate indication from the reviewer or reviewer group as designating in the system according to the file plan that has been designed for the company. Referring back to FIG. 3, the system receives the review indication at step 330. The records manager may now review the reviewer actions and determine whether or not the record should be approved.

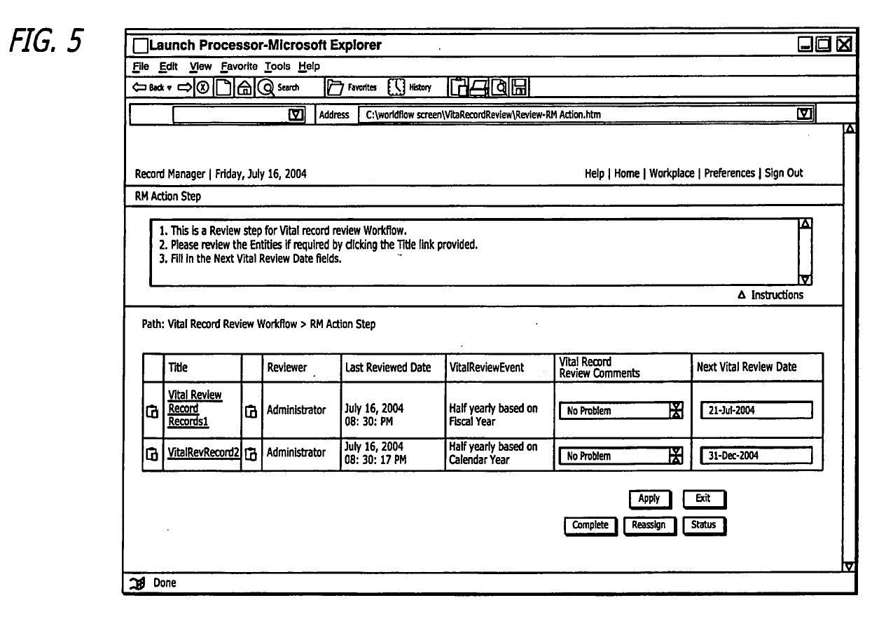

Referring now to FIG. 5, illustrated is a screenshot a records manager might see in a vital record review workflow. As illustrated, the records manager may be shown actions taken by the reviewer and approve the reviewer actions by not editing the comments or indicating acceptance in another manner. In this illustration, the records manager has indicated “no problem” with the records next to the appropriate links.

Referring back to FIG. 3, approval of the record is received at step 340. The record may then be updated at step 350 in with new details as approved by the records manager. The update may include information such as the next vital record review date or other event, the last review date for the vital record or any other information deemed appropriate for the vital record. A records management API may be used to make updates to the record from a workflow.

Cutoff Workflow:

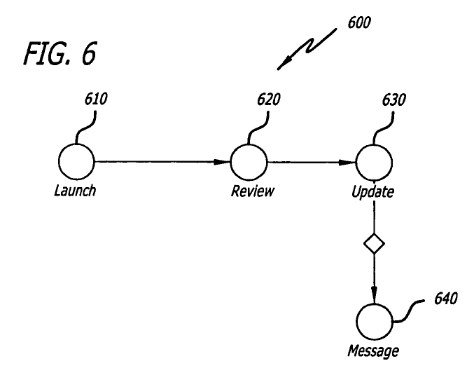

The cutoff workflow described is an example of a workflow that can be created in accordance with the present disclosure. However, it should be understood that a customer can configure, modify, or create new workflows to meet specific business requirements. The workflow may be defined using a process designer which may be a part of a business process management system. Cutoff workflow may then be implemented for a record in order to trigger the disposition phase for a record. Of course, the workflow can be modified or customized—or even new workflows can be created—to meet a business' specific workflow needs. Referring now to FIG. 6, the cutoff workflow 600 may be automatically launched at step 610 upon the occurrence of a cutoff action or event associated with a disposition schedule for a record's classification as defined by the file plan. A cutoff may be defined as a fixed period, or recurring date which defines the point in time at which an electronic volume of a folder is closed and a new volume is to be opened. Cutoff may be used to break, or end the record, at regular intervals in order to permit record disposal in complete blocks and, for correspondence files, to permit the establishment of new files. Cutoffs may be needed before disposition instructions can be applied because retention periods may begin with the cutoff, not with the creation or receipt, of the records. A cutoff workflow may enable a customer to approve cutoff and to optionally perform other records or business related tasks, such as create a new volume.

The launch of the cutoff workflow may be implemented as a result of an automatic nightly sweep by the system in order to discover pertinent dates or other event data related to the cutoff. The cutoff workflow may be designed in a file plan to ensure that the records manager reviews records at 620 and approves the cutoff date at 630 so that the disposition phase for a record may commence. If the records manager approves the cutoff date or event, the records manager may send user input indicating approval. Once the records manager sends approval, it is received by the system and the record is updated accordingly. After approval, the disposition phase may begin, which may result in disposition workflows being launched. The system may send a message at step 640 indicating information relating to the cutoff workflow, including that the cutoff was approved.

Create New Folder Workflow:

In yet another workflow process, workflows may be implemented that relate to creating new folders in a category hierarchy for a record. A customer may configure, modify, or create such workflows to meet specific business needs. The workflow may be defined using a process designer which may be a part of a business process management system. The purpose of such a workflow may be to allow record users to request creation of new record folders. On approval by the records manager, the record folder may be created. This process gives the user an avenue to request creation of a folder. The records administrator or user, in order to maintain consistency within the records management system, may supply the folder name for the new folder and send the new name to the records manager for approval. If the records manager approves the new folder, it is then created.

Screening Workflow:

In yet another workflow process, a screening workflow may be used to implement workflows related to screening records for purposes of approval and execution of record disposition. A customer may configure, modify, or create new screening workflows to meet specific business needs. The workflow may be defined using a process designer which may be a part of a business process management system. The screening workflow may be designed to ensure that a reviewer reviews a record before the execution of the workflow associated with each phase of a disposition schedule. For example, a record may not be immediately destroyed, but may be transferred to another location.

The screening workflow may be launched automatically when a new disposition phase occurs for a record. The screening workflow may be initialized so that a reviewer designated under the file plan, whether a particular end user or reviewer, a records manager or other user, is asked to review the record relative to the specified disposition. Once the system receives an indication that review has occurred and that execution of disposition has been approved, disposal action workflows may be launched.

Disposition Workflows in General:

As yet another example of a workflow in accordance with the present disclosure workflows may be implemented related to the manner of disposal of a record. A customer can configure, modify, or create new disposition workflows to meet specific business requirements. The workflow may be defined using a process designer which may be a part of a business process management system. The collection of disposition workflows can be initiated either manually or automatically based on the disposition schedule. The manner of disposal of a record may include permanent transfer of records to different areas in a classification scheme or to a different system, transfer to backup the record, or disposal by simply destroying the record.

Interim Transfer Disposition Workflow:

As an example of a disposition workflow, an interim transfer workflow may be used to ensure that the home location of a physical record related to an electronic record is changed to a specified location at the end of the related retention period. This workflow would move the record to some other location, but point to that location from the records management system. For example, paper records may be transferred to an off-site storage facility. In the case of electronic records, online records may be stored offline. An interim transfer workflow may be associated with a disposition interim transfer action or event in a disposition schedule of a file plan. The interim transfer may be launched manually, but approved by the records manager. If approved, the pertinent records are transferred to the specified location in the specified format. In this manner, for example, the locating of a paper record could be updated and the pertinent objects could remain in the system for future tracking and destruction.

Transfer Disposition Workflow:

A transfer workflow may be implemented as part of a disposition schedule, and may be associated with a disposition transfer action or event associated with a disposition schedule. The same is true for all other disposition workflows, i.e., they may be associated with a disposition action or event associated with the disposition schedule. A transfer workflow may be used to ensure that the records are transferred to a specified location, such as the National Association of Record Archives or a federal agency at the end of the retention period for a phase. The transfer workflow may be manually launched, but a records manager may be required to approve the transfer. If approved, the records would be transferred to the specified locations in the specified format. A report could be made of the transfer. The report may include the action taken, e.g., transfer, the person performing the action, the date on which the action was performed, the status of the action or transfer. If the transfer failed, the reason for the failure could be reported.

Export Disposition Workflow:

An export workflow may be implemented to ensure that records are copied to a specified location at the end of the retention period for a phase. This workflow could be launched when a disposition export action associated with a disposition schedule is launched. If approved by the records manager, the records would be copied. A report could be generated related to the exportation of the record.

Destroy Disposition Workflow:

A destroy workflow may be implemented to ensure that records are permanently destroyed at the end of a retention period for a phase. The launch could be associated with a disposition destroy action for a phase in a disposition schedule as set forth in a file plan. The destroy workflow may be launched manually, approved by a records manager, and a report generated.

Disposition Review Workflow:

A disposition review workflow may be implemented in order to ensure that the records manager reviews and approves the record at the end of a retention period of a phase. The disposition review may be launched manually and approved by the records manager. If approved, the record is moved to the next phase of the disposition schedule.

Physical Records Management Workflow:

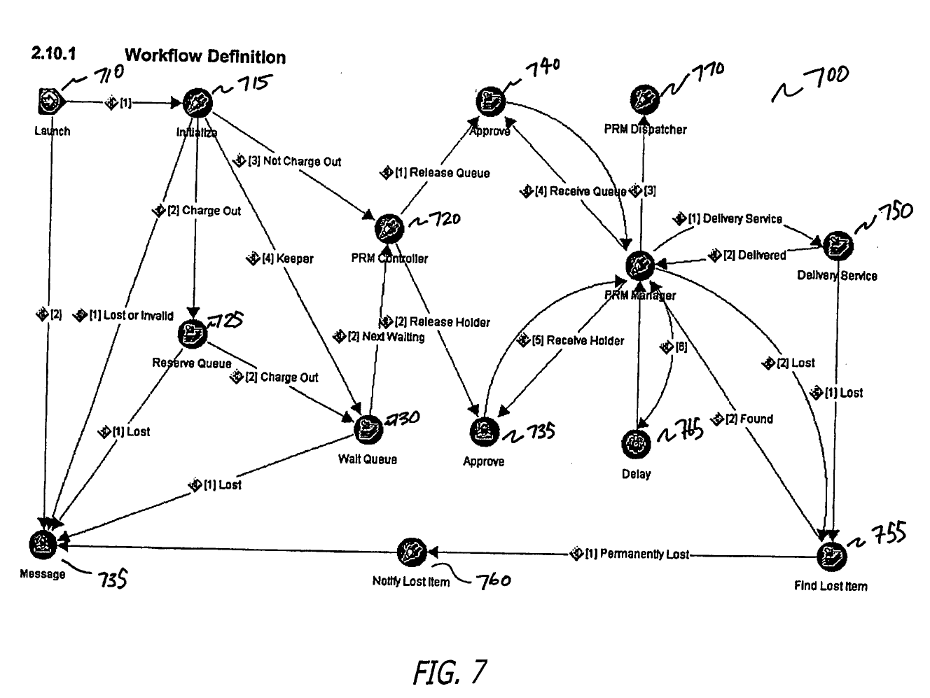

The present disclosure also provides a mechanism for managing physical records. The physical records management (PRM) workflow may be used to implement operations such as charging out, reserving a charged out record, charging in a record, receiving a record, and releasing the record to the next user or record keeper. A customer can configure, modify, or create new PRM workflows to meet specific business requirements. The workflow may be defined using a process designer which may be a part of a business process management system. Referring now to FIG. 7, illustrated is a PRM workflow 700 in accordance with one embodiment of the present disclosure.

The PRM workflow is triggered by an end user when a request for a physical record is made in the records management system. The PRM workflow may be launched at step 710 by the user when the user selects a launch physical record management workflow from a screen related to the record. It should be understood that the PRM workflow will generally be available where charge-out workflow is subscribed for the class. If such a charge-out workflow is not subscribed for a class, such a workflow will generally not be available for the record.

At the time of the launch, the end user may be required to provide certain details to charge out the physical item. These details may include the requesting user, the record requested, the projected return date of the physical record, as well as a user selection of the charge-out location for a physical item. These details may be a part of a reservation request where the record has been charged out. For a single physical item, only one request is processed at a time based on a FIFO algorithm. During the charged-out period, no other user can access the physical item. However, during the charged-out period, reservations may be made for the item. The logic for handling reservations for charged-out records is contained in the workflow, which will make it easier to customize the behavior of the charge-out without modifying the records management application.

The PRM workflow may be initialized at step 715, based on details provided by the user. At initialization, the required data fields for the workflow are input. From the initialization step, other steps in the workflow may be implemented based on one of four conditions: (a) the record is charged out; (b) the current holder is the keeper of the record; (c) the record is not charged out; or (d) the record is lost or invalid.

Based on the first condition, if the record is charged out as determined at initialization step 715, the workflow moves to reserve queue at step 725. All charge-out requests are queued up in the reserve queue step 725. When no work item is waiting at wait queue 730, a work performer picks the next work item from the reserve queue and dispatches to the wait queue step 730 on the basis of a FIFO algorithm. A work performer performs a periodic poll based on a FIFO algorithm to determine whether a previous work item exists and is waiting for delivery. In this manner, work performer is designed to ensure that only one workflow is launched for a single item at a time.

When the work performer determines that no work item awaits delivery, it picks up a work item from the work queue for processing, and sends it to await delivery. The work item awaits delivery and waits for a wait condition to be satisfied. The wait condition may result in the release of the charge-out request for further processing. Alternatively, the wait condition may result in termination of the wait for delivery where the wait condition of lost is satisfied.

It should be understood that when the release step is being processed by one requesting user, a new PRM workflow may be initiated based on an originating charge-out request by yet another user. The new PRM workflow may be launched to set the wait condition such that any waiting work items are released from a wait condition and dispatched to the release step. This step also terminates the current workflow. The work performer polling the work item at the wait for delivery step removes the next work items from the queue and the cycle is repeated until all requests for records are serviced and the work queue becomes empty. If the queue is empty and there is no pending request, it pushes the record holder or keeper into wait for delivery mode. The last user releases the item to record holder/keeper and the physical item returns back to the home location. If the item is lost due to some reason and one or more users are waiting for the item, work items from the work queue and waiting condition corresponding to the lost physical item are terminated, and the users may be suitably notified of the lost status. The status may also set so that any further request for the item is denied.

When no user waits in the wait queue step 730, PRM controller 720 may launch a work item having the keeper as the next receiver.

Based on the second condition, i.e., if the current holder of the record is the keeper of the record as determined at initialization step 715, the workflow moves immediately to the wait queue step 730. When wait conditions are satisfied, the workflow moves to PRM controller step 720.

Based on the third condition, if the record is not charged out at initialization step 715, then the workflow moves to PRM controller step 720. The PRM controller step 720 may launch another work item having the keeper as the next receiver. This is also the mechanism whereby charge-in occurs when a user requests a record and no charge-out requests are outstanding.

Based on the fourth condition, if the record is lost or invalid as determined at initialization step 715, then the workflow moves to message step 735, sending a message to a display accessible by the user, indicating that the requested item is lost or that the user request was invalid. At this point, the PRM workflow may end, and no further action would be taken by the system in connection with the user's charge-out request.

At wait queue step 730. At any given time, this step only contains one wait request to handle the release or charge in. The user who has initiated this request is generally the user who will receive the record after the current holder releases it. The work performer then performs its periodic poll, and when a wait condition is satisfied, the workflow moves to the PRM controller step 720.

At the PRM controller step 720, the current holder of the record is set as the keeper if the record is charged out. Alternatively, the keeper of the record is determined if the record is not charged out at PRM controller step 720.

From the PRM controller, the workflow goes to either the release holder approval step 735 which requires human approval, or the release approval step 740 which requires system approval. In the release holder approval step 735, the current holder approves release of the physical item. The current holder can then take one of the following four actions as controlled by a PRM controller at step 720: (a) deliver the item manually; (b) deliver the item using a delivery service; (c) report the lost item; or (d) delay the release of the item. If the PRM controller determines that the holders action requires system approval, the workflow moves to release approval step 740. If the PRM controller determines that the holder's action requires human approval, the workflow moves to release holder approval step 735.

If the current holder of the record requests manual delivery, and the request is approved at either step 735 or 740, then workflow moves to PRM manager step 745. The physical record may be delivered so that the user receives the item. After receiving the physical item, the receiver becomes the current holder of the item, and the current workflow is terminated at PRM dispatcher step 770.

Alternatively, if the current holder requests use of the delivery service, and the request is approved at either step 735 or 740, then workflow moves to PRM manager step 745 in order to release the item to the requesting user. The delivery service workflow is commenced at step 750. If the delivery service is able to access the record, the record is delivered so that the user receives the item. If the delivery service is unable to find the record, the delivery service may find that the item is lost and attempt to find the lost item at step 755. If the delivery service is still unable to find the lost item, it may notify the user that the item is unavailable at step 760.

A customer-specific mechanism may specify a manner of delivery for a physical record (for example, the physical record may be coming from an offsite location). When such items are delivered, the location (this might include user or physical location) of the physical record is recorded in the system along with the date that it was delivered. If the record is not available because another user is currently in possession of the record, then the system will put the user on a reservation list and notify the user who currently has the object, asking them to deliver it to the requester when they are complete.

If the current holder chooses to delay the user request and the request is approved at either step 735 or 740, the workflow moves to PRM manager step 745. The current holder may make a selection from her screen, indicating that the request should be delayed. The workflow may then be dispatched to the request delayed step 765, and the requesting user is notified. Where no approval authority is necessary to delay time, current holder may decide the duration of the delay. The release date is then set by the current holder and the user may access the record at the end of the delay period.

Once the physical record is indicated as received, whether by manual delivery, delivery service, after a delay process, or otherwise, the current location of the item along with its charge-out status is also updated to reflect the new change. If no work items remain in the work queue, the record is delivered back to the record holder/keeper of the physical item and the workflow terminates. This cycle is repeated until the work queue of the requests becomes empty. The location and status of the items are also updated to reflect the changes.

If a due date has been entered related to a record return, then the system may notify the user that the record is due for charge-in.

Computer Based System and Architecture:

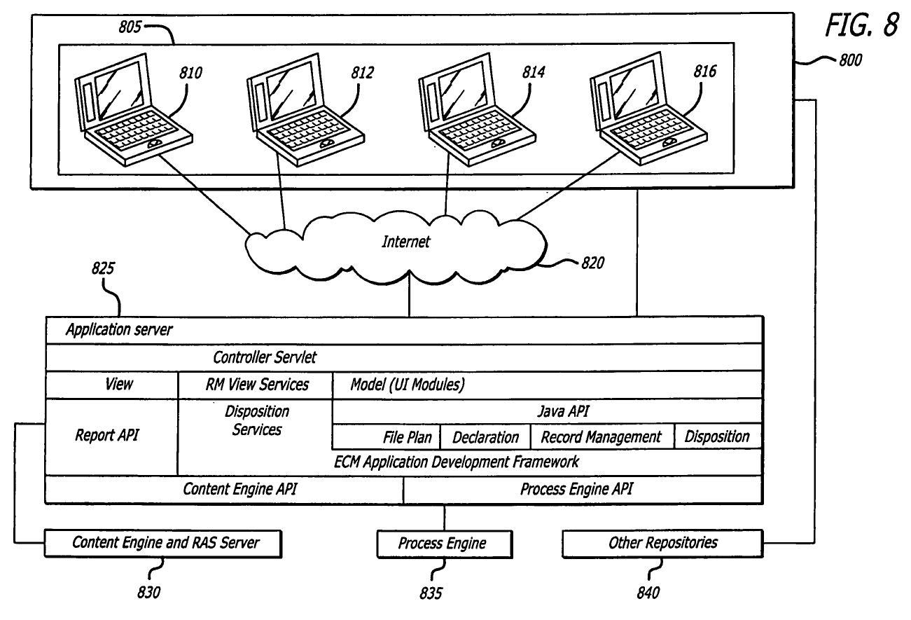

Referring now to FIG. 8, illustrated is a computer-based records management system 800 used to implement the automated declaration and records management processes described in the present disclosure. As shown in FIG. 8, a number of records management clients 810, 812, 814, 816 are coupled via the Internet 820 to an application server 825. The application server 825, is, in turn, operatively coupled to a content engine and report server 830, a process engine 835 and other repositories 840.

The records management clients 810, 812, 814, 816 may be a part of a records administration system 805. The records administration system 805 may include an out-of-the-box web application for records management users, and another out-of-the box web application for records managers/administrators. The end user roles may be a typical end user, a records reviewer, a records manager and records administrator, and each may be assigned workstations 810, 812, 814, 816, respectively. These records management web applications may allow users to add documents, declare documents as records to an object store, browse and search for items and to run workflows.

The application server 825, content engine 830, process engine 835, and other repositories 840 may include computer processing systems that may each operate in conjunction with a memory system, and a user interface. The computer processing systems for the application server 825, content engine 830, process engine 835, and other repositories 840 may be configured to perform any or all portions of the functions described in this disclosure, as well as other functions. For example, the computer processing systems may be configured to manage the various components in the system, including the data contained in the object stores and repositories of the data model, workflows and relationships that are discussed below. The computer processing systems may be configured to create, delete and modify any or all of these components.

The application server 825, content engine 830, process engine 835, and other repositories 840 may be operatively coupled to, or include, any type of computer processing system and may include computer hardware and/or software. The application server 825, content engine 830, process engine 835, and other repositories 840 may be operatively coupled to, or include, a general purpose computer or a computer that is dedicated to the records management system. This computer processing system is referred to at length hereafter.

The computer processing system may include a single computer or multiple computers and/or processors. When using multiple computers and/or processors, the multiple computers and/or processors may be at a single location or at several locations. When using multiple computers and/or processors, the multiple computers and/or processors may be interconnected by a network system, such as a local area network, a wide area network, and/or the Internet. The application server 825, content engine 830, process engine 835, and other repositories 840 may include, or be operatively coupled to, any combination of these embodiments. In the present embodiment, the application server content engine 830, process engine 835, and other repositories 840 are accessible to the records management clients over the Internet 820, a wide area network. As such, certain capabilities are provided to the records management system.

A memory system as disclosed herein may include any type of memory system, including one or more hard disk drives, magnetic tape drives and/or RAMs. The memory system may consist of a single device or multiple devices. When multiple devices are used, they may all be located in close proximity to each other, or at different locations. When multiple devices are used, appropriate hardware and/or software may be used to facilitate their intercommunication. It should be understood that one or more memory systems may be operably coupled to, or included within the application server 825, content engine 830, process engine 835, and other repositories 840 in order to perform the functions described herein.

The records management architecture may support the integration of the custom application, a third-party records management client application that interacts with content engine repositories and Java APIs for the records management-related operations. The records management API may also be used to control access to records by securing repositories containing records. The records management API may further be used to retrieve records based on user search criteria.

The architecture may separate the application object (the model) from the way it is represented to the user (the view) from the way the user controls it. The controller servlet provided may be a controller that translates the interaction with the view into the actions to be performed by the model. The view retrieves the data from the model and then displays the data using the view services. The action performed by the model involves activating the business model.

Disposition services may provide a means to control the life cycle of the record in the record in the records management application. The lifecycle may begin with the initialization of the disposition until the action to destroy the record. The disposition services may include managing the cutoff date, executing disposition, actions and exceptions handling.

The records manager application may provide a declaration API, a record management API, a disposal API, and a file plan management API. A reports API may be used to design, view, process and customize records management-related reports using, for example, a report server 830.

A content engine API may also be provided that contains the classes and interfaces to build Java-based applications that provide access to content engine objects such as object stores, folders, and documents. These content engine APIs may be used by the records management application to access such objects and information about the objects in a content management repository.

A content engine and report server 830 may provide an object-oriented repository for managing content and other business-related data, collectively referred to as objects. The content engine 830 may use active directory services, which may provide authentication services and stores the users and groups that may access the records management system. All events related to the records manager file plan may be defined in the content engine. The events may be internal, external, custom, cyclic or metadata events.

The report server 830 may be a client-server system that enables report creation, processing and manipulation in a multi-tier environment. The report server may be composed of two basic components: the report server and a Software Developer's Kit, that provides an interface to the server. The report server may provide the services for designing, viewing, processing and customizing reports. The report server may be installed in, for example, a Windows 2000™ operating system environment. The report server may use for example, Microsoft OLE™ database provider to communicate with content engine 830. The underlying database may be either on a WINDOWS™ or UNIX™ operating system.

A process management API may also be provided to create a custom process application, such as a work performer or a step processor. The process API classes may be used to enable a user to develop workflow applications using these APIs. The record management application may use these workflow applications to automate records management business processes.

Any one of the functions that are performed by the application server 825 may be performed in response to input from a user interface of the records management clients 810, 812, 814, 816 that originates with one or more users of the records management system. The user interfaces of the records management clients 810, 812, 814, 816 may include any type of user interface components, including one or more keyboards, mice and/or display screens. These user interfaces may include appropriate software to process information. These user interfaces may also include communication links to other computing systems and/or databases.

The memory system may contain a plurality of records management software objects. Each software object may represent data and events associated with classification of a record, including file plans, object stores, or any other information such as that maintained as a part of the data model in FIG. 2. The memory system may also include retention and disposition rules as defined by the file plan.

The memory system that is resident on or coupled to application server 825 may include a plurality of workflow processes. Each workflow process may represent a workflow process relating to a company, including vital record review workflows and cutoff workflows. The workflow process may be a fully automated workflow process or one that requires human intervention at one or more stages of the process. Processes related to the enterprise other than workflow processes may also be stored in the memory system.

The memory system may include a version history which is created and managed by a version control system in the computer processing system. As changes are made to one or more of the components in the records management system, such as to one or more of the object stores, image services repositories, cabinet repositories containing physical documents and box repositories containing physical documents, the version control system may retain information in the version history that will allow each component to be reconstructed to each of its states prior to each of the changes that are made to it. For example, for electronic documents, as the document is revised, the object stores may include the original version as well as the revised version. For physical objects, such as customized items labored on by multiple persons, a record of the changes made by the latest user may be entered, but information related to the original unchanged version of the physical item—or one or more images thereof—may be kept in the physical object repository. Accordingly, the information that is stored in the version history may include complete replicates of earlier component versions and/or merely information indicative of the changes that are made thereto.

The application server 825, content engine 830, process engine 835 or other repositories 840 may include an event management system as part of its computer processing system. The event management system may be configured to cause one or more workflows or processes to be launched and/or to be altered during their execution in response to one or more detected events.

For example, a declaration event may commence the automatic classification process. Also by way of example, a vital record review event may trigger a vital record review workflow during a nightly sweep. Further by way of example, a cutoff workflow event may trigger a cutoff workflow configured to trigger a disposition phase for a record upon approval of the record's disposition. A timer in the computer processing system may be used to provide the timing in connection with such timed events.

A broad variety of processes may be implemented in response to events. These processes may be stored separately, such as in the form of one or more of the workflow processes. They may also be stored as part of the data objects or repositories. These workflow processes may include a screening workflow, a disposition review workflow, a cutoff workflow, an export workflow, an interim transfer workflow, a transfer workflow, a destroy workflow, a vital record review workflow, a create folder workflow, a relocation workflow, a charge-in workflow, a charge-out workflow, and an e-mail notification workflow.

In addition, a check out system may be employed as part of a charge-out workflow in the computer processing system to grant the user of the records management system exclusive access to a data object or repository associated with a physical record. Moreover, the processing system may grant the user exclusive access to a data object or repository that the user is in the process of changing or reviewing.

A security system may be employed in the computer processing system to govern who has access to particular data objects or repositories and the components that may be related to them. The security may be applied at various levels, including to groups of users and/or particular classes of information. For example, general end users may be given different access from reviewers and records managers or records administrators.

An audit system may be included in the computer processing system to keep an audit of accesses that are made, including accesses to the data objects and repositories and associated components. The audit system may keep track of who accesses an object or repository, when it is modified, who authorizes the modification, who generates documentation related to the object or repository, and when these events take place. All of this information may be reported on for auditing and compliance reporting purposes.

A navigation system may be included in the computer processing system to allow a user of the records management system to navigate from one component of the system, such as from a data object or repository, to other components that are related to it. The navigation system may include functionality that allows all relationships to a particular component, such as to a data object or repository, to be displayed, and to allow the user to select from this display the next component with which the user wishes to work. This information may be in the form of a pointer or link.

The records management system may include a different combination of components, as well as additional components. For example, the records management system may include a life cycle management system that manages the life cycle of each data object or repository, such as managing status transitions in the object, review and approval levels, version control, security, retention periods, expiry dates and electronic sign-offs.

External management systems may be linked to the records management system.

The records management system may include a rules-based regulatory reporting system. Regulatory reporting controls may be used to monitor a record's status and plan scheduled activities. Exception reporting may be controlled automatically by the system, once records meet (or fail to meet) certain pre-defined criteria. Business rules may be combined with automated processes to support automatic notifications and exception escalation.

Trends and forecasts may be reported. Using process analyzer and simulation tools, trends and patterns in records management may be identified and explored with what-if scenarios.

As should now be clear, the same component may appear in one or several of many different ways in the records management system.

Similarly, workflow processes may be defined in the system as separate components, such as the workflow processes 300, 600 shown in FIGS. 3 AND 6.

These are but a few examples of the infinite variations that may be implemented.

The various management systems that are shown may, in whole or in part, be consolidated into a single, integrated management system, such as an integrated content management system and process management system.

In this connection, functionality may be increased and costs reduced by delivering all components on a single architecture. Functionality may be increased by the combinations of functionality, and costs may be reduced by reducing the number of systems required to implement a single architecture. Using a single architecture design, one system can manage and work with various types of content. Moreover, one system can manage both the records management file plan, electronic records and paper records.

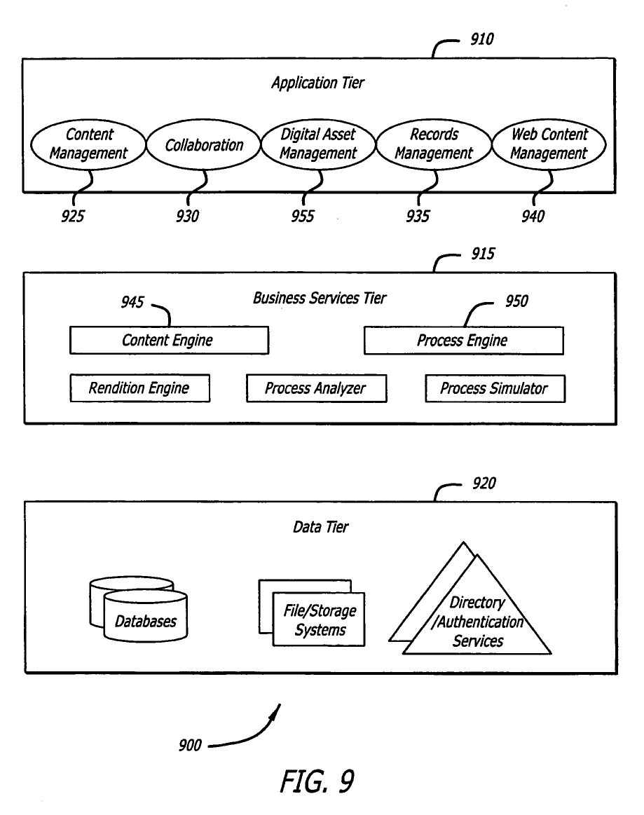

Referring now to FIG. 9, illustrated is a block diagram 900 representation of a single architecture, including an application tier 910, a business services tier 915, and a data tier 920. A single architecture may be provided thereby for content management 925, records management 935, web content management 940, collaboration 930 and digital asset management 955 at the application tier, while a content engine 945 and a process engine 950 are used to manage the process and content for all the separate functions indicated as content management 925, records management 935, web content management 940, collaboration 930 and digital asset management 955.

Using this architecture, system events can trigger actions in any part of the system. When content is added to the system, events may publish the content to the web or declare it as a record. In this manner, the file plan may be managed within the system, and content may be managed both inside and outside the system. The server side may perform record management operations.

The records management system 935, the process management engine system 950 and the data tier 920 shown in FIG. 9 may be configured to monitor the value(s) of one or more events or actions associated with one or more of the data objects associated with records or the file plan. In response to this monitoring and based on one or more pre-defined rules and/or conditions, the records management system 935 may be configured to automatically initiate one or more processes in the process engine system 950. For example, after user declaration of an asset as a record, the system may automatically classify one or more of the records or store information associated with one or more of these records in the records management system. One or more of these processes may in addition or instead apply one or more pre-defined retention periods or disposition rules to one or more of the records.

Alternatively, one or more of the various management systems may be separate, stand-alone systems that have been brought together and integrated merely for the purpose of creating the records management system.

The previous description of the disclosed embodiments is provided to enable one skilled in the art to make or use the present disclosure. Various modifications to these embodiments will be readily apparent to those skilled in the art. The principles set forth herein may be applied to other embodiments without departing from the spirit or scope of the disclosure. Thus, the present disclosure is not intended to be limited to the embodiments shown herein but is to be accorded the widest scope consistent with the principles and novel features disclosed herein.

We claim:

1. A computer-based method for managing records based on automated records classification, comprising:
receiving a file plan configured to classify records, including physical and electronic records;
receiving declaration of an asset as a record;
automatically classifying the record according to the file plan;
managing the record according to the file plan, including implementing workflows associated with managing the record.

2. The method as recited in claim 1, wherein the managing step includes automatically launching a vital record review workflow based on a vital record review event associated with the record's classification.

3. The method as recited in claim 2, wherein the managing step further comprises:
receiving an indication that a vital record has been reviewed by each designated reviewer; and
updating the vital record.

4. The method as recited in claim 2, wherein the vital record review event is based on the passage of a period of time.

5. The method as recited in claim 1I wherein the managing step includes automatically launching a cutoff workflow based on a cutoff event associated with the record's classification.

6. The method as recited in claim 5, wherein the cutoff event is a cutoff date based on the passage of a period of time.

7. The method as recited in claim 5, further comprising:
receiving approval of the record's cutoff date; and
disposing of the record according to the record's classification, wherein the file plan includes a disposition schedule associated with the record's classification.

8. The method as recited in claim 1, wherein the managing step includes:
automatically launching a screening workflow, wherein the screening workflow is configured to require a user designated under the file plan to review a record before executing a workflow associated with managing the record; and
implementing the screening workflow according to the file plan.

9. The method as recited in claim 1, wherein the managing step includes:
receiving a request to launch a disposition review workflow that is configured to require a user to review and approve a record at the end of a retention period of a disposition phase, the retention period being defined by the file plan, and wherein the disposition phase includes at least one of a interim transfer, transfer, export and destroy workflow; and
in response to the request, launching and implementing the disposition review workflow.

10. The method as recited in claim 1, wherein the managing step includes:
launching, based on the disposition schedule, an interim transfer workflow that is configured to require that the home location of a physical record or the location of an electronic records is changed to a specified location at the end of a retention period of a disposition phase such that the record may be further managed, wherein the disposition phase is defined by the file plan; and
in response to the request, launching and implementing the interim transfer workflow.

11. The method as recited in claim 10, wherein the managing step further includes, prior to the interim transfer launching step, receiving approval for the launch.

12. The method as recited in claim 1, wherein the managing step includes:
receiving a request to launch a transfer workflow that is configured to require that records are transferred to a specified location at the end of a retention period of a disposition phase, wherein the disposition phase is defined by the file plan; and
in response to the request, launching and implementing the transfer workflow.

13. The method as recited in claim 12, wherein the managing step further includes, prior to the transfer launching step, receiving approval for the launch.

14. The method as recited in claim 1, wherein the managing step includes:
receiving a request to launch an export workflow that is configured to require that records are copied to a specified location at the end of a retention period of a disposition phase, and
in response to the request, launching the export workflow.

15. The method as recited in claim 14, wherein the managing step further includes, prior to the export launching step, receiving approval for the launch.

16. The method as recited in claim 1, wherein the managing step includes:
receiving a request to launch a physical records management workflow that is configured to manage charge-out, reservation, or charge-in of physical records; and
in response to the request, launching and implementing the physical records management workflow.

17. The method as recited in claim 1, wherein the managing step includes:
receiving a request to launch a create record folder workflow that is configured to permit users to create record folders; and
in response to the request, launching and implementing the create record folder workflow.

18. The method as recited in claim 1, implementing a workflow in connection with the creation of a record, wherein the record is declared or classified automatically based on contextual information collected about the record in the course of processing the record in the workflow.

19. A computer-based method for automatic implementation of review of vital records, comprising:
receiving declaration of an asset as a vital record:
receiving a vital record review event configured to launch a vital record review workflow associated with the vital record, wherein the vital record review event is associated with at least one designated reviewer, and
upon determination of the occurrence of the vital record review event, automatically launching the vital record review workflow.

20. The method as recited in claim 19, wherein the vital record review event is based on the passage of a period of time.

21. The method as recited in claim 19, further comprising:
receiving an indication that the vital record has been reviewed by each designated reviewer; and
updating the vital record.

22. The method as recited in claim 20, further comprising:
prior to the updating step, receiving an indication that the record has been approved by an end user other than a designated reviewer; and
updating the vital record.

23. The method as recited in claim 19, further comprising:
launching one or more disposition workflows, either in response to a user request or automatically, based on a disposition schedule.

24. A method for reviewing a record in a records management system in order to approve disposition of the record, comprising:
receiving a cutoff event configured to launch a cutoff workflow associated with the record, wherein the cutoff event is contingent upon an approval of at least one end user;
upon determination of the occurrence of the cutoff event, automatically launching the cutoff workflow;
transmitting information associated with the cutoff event to the at least one end user upon whom the approval of the cutoff event is contingent;
after receiving an indication of approval by the at least one end user, commencing a disposition phase for the record.

25. The method as recited in claim 24, wherein the cutoff event is based on the passage of a period of time.

26. A unified computer-based records management system for managing records based on automated record classification, comprising:
a memory system including a file plan configured to classify a record, wherein the memory system is configured to receive declaration of an asset as a record;
a classification device configured to automatically classify the record according to the file plan; and
a records management system configured to initiate management of the record according to the file plan.

27. The records management system of claim 26, further comprising:
a process engine system, wherein the process engine system is configured to implement at least one process specified by a workflow associated with the record; and
wherein the records management system is further configured to automatically initiate one or more processes in the process engine system.

28. The records management system of claim 27, wherein the one or more processes includes a vital record review workflow that is automatically launched based on a vital record review event associated with the record's classification.

29. The records management system of claim 27, wherein the one or more processes includes a cutoff workflow that is automatically launched based on a cutoff event associated with the record's classification.

30. The records management system of claim 27, wherein the one or more processes includes a screening workflow that is automatically launched based on a screening event associated with the record's classification.

31. The records management system of claim 27, wherein the one or more processes includes a disposition review workflow that is configured to require a user to review and approve a record at the end of a retention period of a disposition phase, the retention period being defined by the file plan, and wherein the disposition phase includes at least one of a interim transfer, transfer, export and destroy workflow.

32. The records management system of claim 27, wherein the one or more processes includes an interim transfer workflow that is configured to require that the home location of a physical record or the location of an electronic record is changed to a specified location at the end of a retention period of a disposition phase such that the record may be further managed, wherein the disposition phase is defined by the file plan.

33. The records management system of claim 27, wherein the one or more processes includes a transfer workflow that is configured to require that records are transferred to a specified location at the end of a retention period of a disposition phase, wherein the disposition phase is defined by the file plan.

34. The records management system of claim 27, wherein the one or more processes includes an export workflow that is configured to require that records are copied to a specified location at the end of a retention period of a disposition phase.

35. The records management system of claim 27, wherein the one or more processes includes a physical records management workflow that is configured to manage charge-out of physical records.

36. The records management system of claim 27, wherein the one or more processes includes a create record folder workflow that is configured to permit users to create record folders.

37. The records management system of claim 27, wherein a single architecture is provided such that one content engine and one process engine manage the content and processes for all the content management, records management, web content management, collaboration and digital asset management.

38. Computer-readable media containing programming for managing records based on automated records classification that, when executed on a computer, causes a processor to perform the steps of:
receiving a file plan configured to classify records, including physical and electronic records;
receiving declaration of an asset as a record;
automatically classifying the record according to the file plan; and
managing the record according to the file plan, including implementing workflows associated with managing the record.

39. The computer program as recited in claim 38, wherein the managing step includes automatically launching a vital record review workflow based on a vital record review event associated with the record's classification.

40. The computer program as recited in claim 39, wherein the managing step further comprises:
receiving an indication that a vital record has been reviewed by each designated reviewer; and
updating the vital record.

41. The computer program as recited in claim 39, wherein the vital record review event is based on the passage of a period of time.

42. The computer program as recited in claim 38, wherein the managing step includes automatically launching a cutoff workflow based on a cutoff event associated with the record's classification.

43. The computer program as recited in claim 42, wherein the cutoff event is a cutoff date based on the passage of a period of time.

44. The computer program as recited in claim 42, further comprising:
receiving approval of the record's cutoff date; and
disposing of the record according to the record's classification, wherein the file plan includes a disposition schedule associated with the record's classification.

45. The computer program as recited in claim 38, wherein the managing step includes:
automatically launching a screening workflow, wherein the screening workflow is configured to require a user designated under the file plan to review a record before executing a workflow associated with managing the record; and
implementing the screening workflow according to the file plan.

46. The computer program as recited in claim 38, wherein the managing step includes:
receiving a request to launch a disposition review workflow that is configured to require a user to review and approve records at the end of a retention period of a disposition phase, the retention period being defined by the file plan, and wherein the disposition phase includes at least one of a interim transfer, transfer, export and destroy workflow; and
in response to the request, launching and implementing the disposition review workflow.

47. The computer program as recited in claim 38, wherein the managing step includes:
launching, based on the disposition schedule, an interim transfer workflow that is configured to require that the home location of a physical record or the location of an electronic record is changed to a specified location at the end of a retention period of a disposition phase such that the record may be further managed, wherein the disposition phase is defined by the file plan; and
in response to the request, launching and implementing the interim transfer workflow.

48. The computer program as recited in claim 47, wherein the managing step further includes, prior to the interim transfer launching step, receiving approval for the launch.

49. The computer program as recited in claim 38, wherein the managing step includes:
receiving a request to launch a transfer workflow that is configured to require that records are transferred to a specified location at the end of a retention period of a disposition phase, wherein the disposition phase is defined by the file plan; and
in response to the request, launching and implementing the transfer workflow.

50. The computer program as recited in claim 49, wherein the managing step further includes, prior to the transfer launching step, receiving approval for the launch.

51. The computer program as recited in claim 38, wherein the managing step includes:
receiving a request to launch an export workflow that is configured to require that records are copied to a specified location at the end of a retention period of a disposition phase, and
in response to the request, launching the export workflow.

52. The method as recited in claim 51, wherein the managing step further includes, prior to the export launching step, receiving approval for the launch.

53. The computer program as recited in claim 38, wherein the managing step includes:
receiving a request to launch a physical records management workflow that is configured to manage charge-out, reservation, or charge-in of physical records; and
in response to the request, launching and implementing the physical records management workflow.

54. The computer program as recited in claim 38, wherein the managing step includes:
receiving a request to launch a create record folder workflow that is configured to permit users to create record folders; and
in response to the request, launching and implementing the create record folder workflow.

55. The computer program as recited in claim 38, implementing a workflow in connection with the creation of a record, wherein the record is declared or classified automatically based on contextual information collected about the record in the course of processing the record in the workflow.

56. Computer-readable media containing programming for automatic implementation of review of vital records that, when executed on a computer, causes a processor to perform the steps of:
receiving declaration of an asset as a vital record:
receiving a vital record review event configured to launch a vital record review workflow associated with the vital record, wherein the vital record review event is associated with at least one designated reviewer; and
upon determination of the occurrence of the vital record review event, automatically launching the vital record review workflow.

57. The computer program as recited in claim 56, wherein the vital record review event is based on the passage of a period of time.

58. The computer program as recited in claim 56, further comprising:
receiving an indication that the vital record has been reviewed by each designated reviewer; and
updating the vital record.

59. The computer program as recited in claim 58, further comprising:
prior to the updating step, receiving an indication that the record has been approved by an end user other than a designated reviewer; and
updating the vital record.

60. The method as recited in claim 59, further comprising:
launching one or more disposition workflows, either in response to a user request or automatically, based on a disposition schedule.

61. Computer-readable media containing programming for reviewing a record in a records management system in order to approve disposition of the record that, when executed on a computer, causes a processor to perform the steps of:
receiving a cutoff event configured to launch a cutoff workflow associated with the record, wherein the cutoff event is contingent upon an approval of at least one end user;
upon determination of the occurrence of the cutoff event, automatically launching the cutoff workflow;
transmitting information associated with the cutoff event to the at least one end user upon whom the approval of the cutoff event is contingent; and
after receiving an indication of approval by the at least one end user, commencing a disposition phase for the record.

62. The computer program as recited in claim 61, wherein the cutoff event is based on the passage of a period of time.
